(19) United States
(12) Patent Application Publication
(10) Pub. No.: US 2024/0120125 A1
(43) Pub. Date: Apr. 11, 2024

(54) CROSSTALK SUPPRESSION WITH LOCAL CONTROLS

(71) Applicant: DUKE UNIVERSITY, Durham, NC (US)

(72) Inventors: Shilin HUANG, Durham, NC (US); Ye WANG, Durham, NC (US); Kenneth BROWN, Durham, NC (US)

(21) Appl. No.: 18/107,942

(22) Filed: Feb. 9, 2023

Related U.S. Application Data
(60) Provisional application No. 63/308,399, filed on Feb. 9, 2022.

(51) Int. Cl. G21K 1/00; G06N 10/20

(52) U.S. Cl. CPC G21K 1/003; G06N 10/20

(57) ABSTRACT

Technologies for suppressing effects of crosstalk in a quantum circuit of a quantum computing system are disclosed. A pair of target qubits on which to perform a quantum gate operation is selected. The quantum gate operation is performed. A rotation is induced on the target qubits such that crosstalk between any of the target qubits and any of the neighboring qubits in the quantum circuit is canceled out.

### CROSS-REFERENCE TO RELATED APPLICATIONS

This application claims the benefit of priority from U.S. Provisional Application No. 63/308,399, filed Feb. 9, 2022, the disclosure of which is hereby incorporated by reference herein in its entirety.

### GOVERNMENT LICENSE RIGHTS

This invention was made with government support under W911NF-16-1-0082, awarded by Intelligence Advanced Research Projects Activity (IARPA)/ARO, and under 1730104, awarded by the National Science Foundation (NSF). The government has certain rights in the invention.

### FIELD

The present disclosure generally relates to quantum computing, and more specifically to techniques for applying local controls to suppress crosstalk in a quantum computing system.

### BACKGROUND

Crosstalk is an error that naturally occurs in quantum computing systems and worsens as these systems continue to scale. In the context of quantum computing, crosstalk generally can pertain to an unwanted coupling of qubits that results in unintended effects. For example, crosstalk may occur in quantum entanglement gate operations. Quantum entanglement gate operations involve creating an entangled state between a pair of qubits such that the quantum state of each qubit cannot be described independently of the quantum state of the other, resulting in a correlation that allows for immediate data sharing between the qubits. Typically, a quantum computing system effects entanglement by physically manipulating the target pair of qubits in a quantum circuit. For instance, an ion trap quantum computing system generates entanglement using laser pulses to induce oscillations on the target qubits as a two-qubit gate operation. However, imperfections in the laser mechanism can result in “spillover” to neighboring spectator qubits in the ion trap, creating crosstalk in the form of unintended two-qubit gates, basically entangling one of the target qubits and a neighboring qubit. Such crosstalk would yield correlations that negatively impact an underlying quantum computation.

### SUMMARY

Embodiments presented herein disclose techniques suppressing crosstalk via local controls, e.g., by sending control signals to target qubits for an underlying operation (rather than to neighboring qubits potentially affected by crosstalk).

For example, one embodiment presented herein discloses a method for suppressing crosstalk in a quantum circuit using local controls. The method generally includes selecting, from a plurality of qubits in the quantum circuit, a pair of target qubits on which to perform a quantum gate operation. The method also generally includes performing the quantum gate operation on the pair of target qubits and inducing a rotation on at least one of the target qubits. Crosstalk between any of the target qubits and any other of the plurality of qubits in the quantum circuit resulting from the performance of the quantum gate operation is canceled out.

Another embodiment presented herein discloses a quantum computing system having a quantum circuit, one or more processors, and a memory storing program code having a plurality of instructions. The plurality of instructions, when executed by the one or more processors, causes the quantum computing system to select, from a plurality of qubits in the quantum circuit, a pair of target qubits on which to perform a quantum gate operation. The plurality of instructions further causes the quantum computing system to perform the quantum gate operation on the pair of target qubits. The plurality of instructions further causes the quantum computing system to induce a rotation on at least one of the target qubits. Crosstalk between any of the target qubits and any other of the plurality of qubits in the quantum circuit resulting from the performance of the quantum gate operation is canceled out.

Yet another embodiment presented herein discloses a computer-readable storage medium storing a plurality of instructions. The plurality of instructions, when executed by one or more processors, causes a quantum computing system to select, from a plurality of qubits in the quantum circuit, a pair of target qubits on which to perform a quantum gate operation. The plurality of instructions further causes the quantum computing system to perform the quantum gate operation on the pair of target qubits. The plurality of instructions further causes the quantum computing system to induce a rotation on at least one of the target qubits. Crosstalk between any of the target qubits and any other of the plurality of qubits in the quantum circuit resulting from the performance of the quantum gate operation is canceled out.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a partial view of an example ion trap quantum computer configured to suppress crosstalk using local controls, according to an embodiment;

FIG. 2 is a conceptual circuit diagram depicting an example of crosstalk on a two-qubit gate in a five-qubit system, according to an embodiment;

FIG. 3 is a conceptual circuit diagram depicting crosstalk suppression with local controls on the example of FIG. 2, according to an embodiment;

FIG. 4 is a flow diagram of an example method flow for suppressing crosstalk using local controls, according to an embodiment;

FIG. 5 is a conceptual diagram representing an encoding for a ¹⁷¹Yb⁺ ion qubit, according to an embodiment;

FIG. 6 is a line graph of experimental data comparing various crosstalk suppression methods according to an embodiment;

FIGS. 7A and 7B are conceptual diagrams of an example crosstalk scenario in an ion trap quantum computing system, according to an embodiment;

FIG. 8 is a conceptual graph illustrating ion populations after inducing consecutive rotations to target ions, according to an embodiment;

FIG. 9 are conceptual circuit diagrams illustrating crosstalk suppression techniques in a Molmer-Sorensen gate; and

FIG. 10 depicts conceptual graphs illustrating results for a two-qubit Bell state infidelity and spectator ion population plotted against a number of consecutive gates under given conditions, according to an embodiment.

### DETAILED DESCRIPTION

Currently, various approaches exist for mitigating crosstalk. For example, one approach is physical, e.g., providing hardware capable of producing signals that target qubits more accurately, designing optical addressing systems that minimize optical aberrations, spatially modulating multiple beams that interfere at qubit locations to achieve super-resolution addressing, etc. Other approaches are algorithmic, in which the quantum computing system includes control logic to minimize crosstalk. Such algorithmic approaches, however, focus on identifying all qubits that would be affected by crosstalk and applying control signals to the identified qubits to compensate for the crosstalk, resulting in significant overhead in execution time. For instance, for two-qubit entangling gates, an example gate-level approach includes applying echoing pulses to all neighboring spectator qubits to cancel crosstalk interaction. Although such an approach may reduce crosstalk, the implementation would increase the amount of single-qubit gates.

Embodiments presented herein disclose techniques for suppressing crosstalk in a quantum computing system. More particularly, the techniques are directed to suppressing first-order crosstalk on a gate-level using local controls, i.e., sending control signals to qubits targeted for a specified interaction (e.g., an entanglement gate operation) without controlling other qubits affected by crosstalk in the underlying quantum circuit. As further described herein, the quantum computing system applies local rotations on target qubits in the middle of a two-qubit gate (e.g., an entangling gate) such that when the target qubits are controlled (e.g., by a laser pulse, a control line, a resonator, etc.), inadvertent interactions on the target qubit by other non-targeted qubits are canceled out by the rotations.

Advantageously, the quantum computing system applies local controls to target qubits, i.e., rotations on the target qubits to account for and cancel out potential crosstalk, without needing to address neighboring qubits. In contrast with previous approaches which also involve applying controls to affected qubits other than the affected target qubits, the present approach improves performance of the quantum computing system by reducing the execution time in mitigating crosstalk within the underlying quantum circuit, resulting in accurate and faster computation. Further, in addition to suppressing crosstalk between a target qubit and neighboring qubits, the present approach establishes a foundation for potentially mitigating crosstalk between each of the target qubits.

Note, the present disclosure uses a trapped ion quantum computer as a reference example for adapting a generator coefficient framework for quantum error correction. However, one of skill in the art will recognize that in addition to trapped ion quantum computers, the embodiments may be adapted to other types of quantum computing systems (e.g., quantum annealing systems, superconductor circuit quantum computers, spin qubit quantum computers, etc.) capable of implementing Hamiltonian systems in the form of:

H=H_{ideal}+H_{crosstalk} (1)

H_{ideal}=Ω₀₁σ_{\vec{n}}_{₀}σ_{\vec{n}}_{₁} (2)

H_{crosstalk}=Σ_{j>1}(Ω₀ⱼσ_{\vec{n}}_{₀}+Ω₁ⱼσ_{\vec{n}}_{₁})σ_{\vec{n}}_{ⱼ}, Ω₀ⱼ,Ω₁ⱼ<<Ω₀₁, (3)

in which H_{ideal}=Ω₀₁σ_{\vec{n}}_{₀}σ_{\vec{n}}_{₁} is a desired interaction between two target qubits 0 and 1, H_{crosstalk} is the crosstalk Hamiltonian representing interactions between target qubits and non-target qubits, \vec{n}ᵢ=(nᵢ^{x},nᵢ^{y},nᵢ^{z}) is a three-dimensional unit vector and σₙ_{ᵢ}=nᵢ^{x}X+nᵢ^{y}Y+nᵢ^{z}Z.

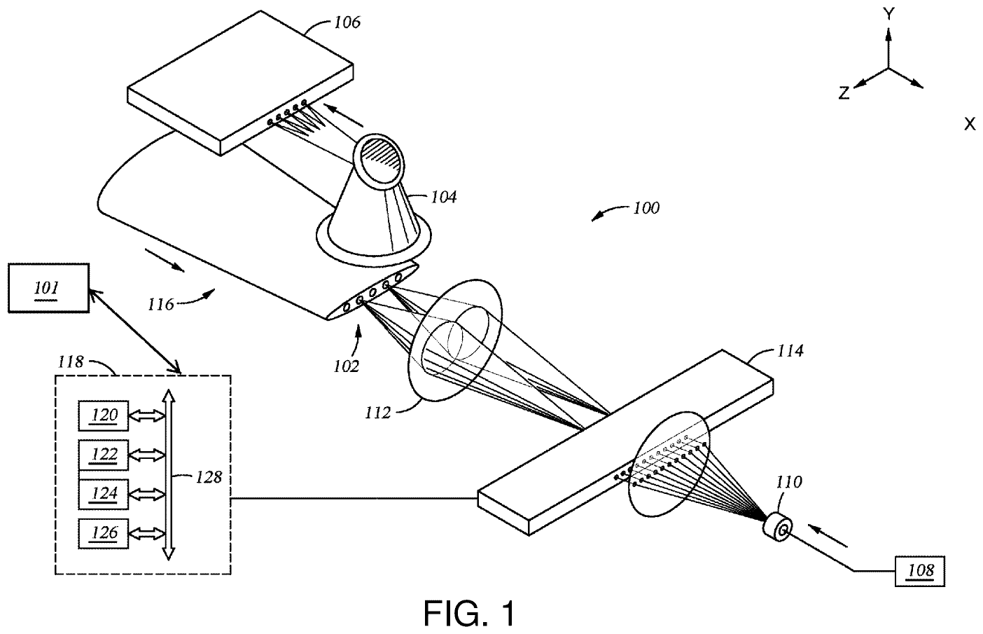

FIG. 1 is a partial view of an example ion trap quantum computer, or system 100, that may implement the techniques described herein, according to one embodiment. The system 100 includes a classical (digital) computer 101, a system controller 118 and a quantum register that is a chain 102 of trapped ions (i.e., five shown) that extend along the Z-axis. The classical computer 101 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 104, such as an objective lens with a numerical aperture (NA), for example, of 0.37, collects fluorescence along the Y-axis from the ions and maps each ion onto a multi-channel photo-multiplier tube (PMT) 106 for measurement of individual ions. Non-copropagating Raman laser beams from a laser 108, which are provided along the X-axis, perform operations on the ions. A diffractive beam splitter 110 creates an array of static Raman beams 112 that are individually switched using a multi-channel acousto-optic modulator (AOM) 114 and is configured to selectively act on individual ions. Of course, other methods of single beam delivery (e.g., micromirror devices, multi-channel acousto-optic modulators, acousto-optic deflectors, etc.) may be implemented to drive ions in the system 100. For instance, in some embodiments, micro-electromechanical system (MEMS) mirrors (not shown) may be used. A global Raman laser beam 116 illuminates all ions at once.

The system controller (also referred to as a “RF controller”) 118 controls the AOM 114. The system controller 118 includes a central processing unit (CPU) 120, a read-only memory (ROM) 122, a random access memory (RAM) 124, a storage unit 126, and the like. The CPU 120 is a processor of the RF controller 118. The ROM 122 stores various programs and the RAM 124 is the working memory for various programs and data. The storage unit 126 includes a nonvolatile memory, such as a hard disk drive (HDD) or a flash memory, and stores various programs even if power is turned off. The CPU 120, the ROM 122, the RAM 124, and the storage unit 126 are interconnected via a bus 128.

The RF controller 118 executes a control program which is stored in the ROM 122 or the storage unit 126 and uses the RAM 124 as a working area. The control program will include software applications that include program code that may be executed by the processor to perform various functionalities associated with receiving and analyzing data and controlling any and all aspects of the methods and hardware used to create the ion trap quantum computer system 100 discussed herein. For example, the control program may include program code for locally suppressing crosstalk during a quantum gate operation (e.g., an entanglement gate operation), such as program code for receiving information of a quantum circuit of the system 100 in which to perform the quantum gate operation, selecting target ions in the chain representing qubits in the quantum system on which to perform the quantum gate operation, performing the quantum gate operation on the target ions, and inducing a rotation on the target ions (e.g., by configuring tuning parameters for the laser 108 to generate echoing pulses sufficient to induce such rotation).

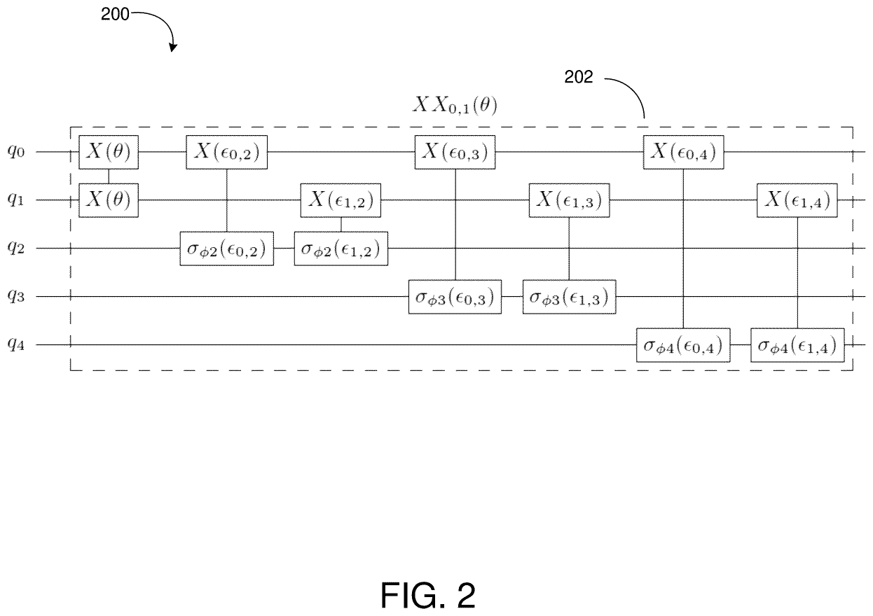

Referring now to FIG. 2, an example 200 of a Molmer-Sorensen (MS) gate 202 is shown, in which the gate 202 is affected by crosstalk. As known, a MS gate is a two-qubit entangling gate used in trapped ion architectures, in which the gate 202 uses collective motional modes to entangle the internal electronic states of underlying qubits. MS gates have relatively high fidelity under axial motional modes and under radial motional modes with individual addressing. Further, while the MS gate 202 is used in this example 200 for an entangling gate in which the techniques described herein may be applied, one of skill in the art will recognize that the technique can also be applied on other types of entangling gates, such as phase-shift entangling gates, two-qubit gates based on light shift, and other physical platforms with interaction Hamiltonians.

The example gate 202 is provided on a five-qubit system, in which q₀ and q₁ are target qubits and q₂, q₃, and q₄ are neighboring qubits. Particularly, the gate 200 depicts unwanted entangling interactions between qubit pairs (q₀, q₂), (q₁, q₂), (q₀, q₃), (q₁, q₃), (q₀, q₄), and (q₁, q₄). Referring to Hamiltonians (2) and (3), the gate 202 has σ_{\vec{n}}_{₀}=σ_{\vec{n}}_{₁}=σ_{X}. In a trapped ion quantum computing system, such as the system 100, crosstalk mainly occurs as a result of residual illumination of neighboring ions by laser light during gate applications due to the finite size of the focused beam spot. The crosstalk may originate, for example, from the static Raman beams 112 from the laser 108 spilling over to untargeted ions (qubits). The unintended correlations may result in quantum computing errors and compound with the greater amount of crosstalk.

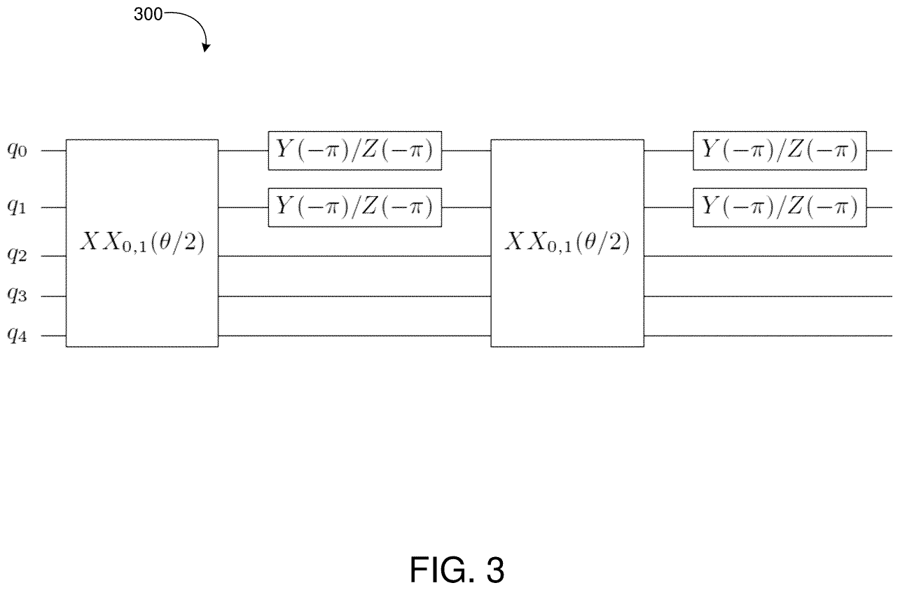

Referring now to FIG. 3, an example 300 of the gate 202 is shown, in which the local controls are applied to the target qubits q₀ and q₁ to suppress the effects of crosstalk therein. In this example, the system 100 inserts a π-rotation along the Y (or Z) axis in the middle of the gate 200. The axis of the single-qubit π-rotation, \vec{n}ᵢ^{⊥}, could be any axis perpendicular to \vec{n}ᵢ^{⊥}. In the example 300, \vec{n}₀=\vec{n}₁=X. Therefore, \vec{n}ᵢ^{⊥} can be any axis in the YZ plane. In practice, \vec{n}ᵢ^{⊥} can be Y or Z for convenience. Two single-qubit rotations effectively reverses the interactions between the target qubits and the non-target qubits on the second half of the gate, as depicted in the example 300. By reversing the interactions, the system 100 cancels out the crosstalk elements. Further, because XX_{0,1}(θ/2) (the Mølmer-Sørensen interaction) commutes with Y₀(π)⊗Y₁(π), the system 100 is able to preserve the intended entangling operation XX_{0,1}(θ).

Reversing and preserving the interactions can occur because operator σₙ_{₁}_{^{⊥}}(π)σₙ_{₂}_{^{⊥}}(π) anti-commutes with H_{crosstalk} while commuting with H_{ideal}. Therefore

U_{ideal}=σ_{\vec{n}}_{₁}_{^{⊥}}(−π)σ_{\vec{n}}_{₂}_{^{⊥}}(−π)e^{-iH}^{_{ideal}}^{t/2}σ_{\vec{n}}_{₁}_{^{⊥}}(π)σ_{\vec{n}}_{₂}_{^{⊥}}(π)e^{-iH}^{_{ideal}}^{t/2)}=σ_{\vec{n}}_{₁}_{^{⊥}}(−π)σ_{\vec{n}}_{₂}_{^{⊥}}(−π)σ_{\vec{n}}_{₁}_{^{⊥}}(π)σ_{\vec{n}}_{₂}_{^{⊥}}(π)e^{-iH}^{_{ideal}}^{t/2}e^{-iH}^{_{ideal}}^{t/2}=e^{-iH}^{_{ideal}}^{t} (4)

U_{crosstalk}=σ_{\vec{n}}_{₁}_{^{⊥}}(−π)σ_{\vec{n}}_{₂}_{^{⊥}}(−π)e^{-iH}^{_{crosstalk}}^{t/2}σ_{\vec{n}}_{₁}_{^{⊥}}(π)σ_{\vec{n}}_{₂}_{^{⊥}}(π)e^{-iH}^{_{crosstalk}}^{t/2)}=σ_{\vec{n}}_{₁}_{^{⊥}}(−π)σ_{\vec{n}}_{₂}_{^{⊥}}(−π)σ_{\vec{n}}_{₁}_{^{⊥}}(π)σ_{\vec{n}}_{₂}_{^{⊥}}(π)e^{-iH}^{_{crosstalk}}^{t/2}e^{-iH}^{_{crosstalk}}^{t/2}=Identity. (5)

The interaction between neighboring ions and target ions are cancelled while the interaction between target ions are preserved.

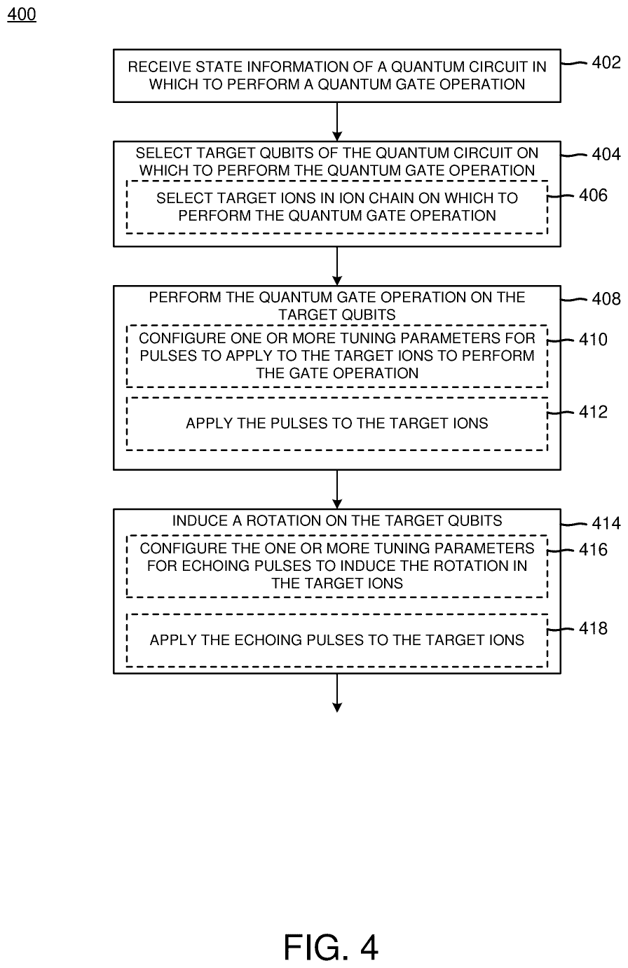

Referring now to FIG. 4, the system 100, in operation, may perform a method 400 for suppressing crosstalk using local controls. As shown, the method 400 begins in block 402, in which the system 100 ascertains quantum state information of a quantum circuit to perform a quantum gate operation, such as a quantum entanglement gate operation.

In block 404, the system 100 selects target qubits in the quantum circuit on which to perform the quantum gate operation. For instance, given a trapped ion quantum computing system, such as system 100, the system 100 may select target ions in the chain 102 on which to perform the quantum gate operation (in block 406). In block 408, the system 100 performs the quantum gate operation, targeting the selected pair of qubits (ions). For example, to do so, in block 410, the system 100 may configure one or more tuning parameters of the laser 108 such that the system 100 applies pulses at a specified frequency for performing the gate operation. Given the systems described by (1)-(3) provided above, in implementing the quantum gate operation exp(−iH_{ideal}t), the system 100 may instead implement exp(−iHt). In block 412, the system 100 applies the pulses to the target ions.

In block 414, the system 100 induces a rotation on each the target qubits. To do so, the system 100 may insert local π-rotations on the target qubits in the middle of the underlying entangling gate. To do so, in block 416, the system 100 may configure the one or more tuning parameters such that the laser 108 generates echoing pulses to induce the rotations. More particularly, the system 100 may manipulate the radio frequency signals applied on AOM 114 to drive stimulated Raman transitions on the underlying ions. With precise control on frequencies and phases of RF signals, the system 100 can achieve arbitrary single-qubit rotations on underlying ions. In block 418, the system 100 may apply the echoing pulses to the target ions. More specifically, to accurately implement exp(−iH_{ideal}t) discussed above, the system 100 applies the pulse

U=σ_{\vec{n}}_{₁}_{^{⊥}}(−π)σ_{\vec{n}}_{₂}_{^{⊥}}(−π)e^{-iHt/2}σ_{\vec{n}}_{₁}_{^{⊥}}(π)σ_{\vec{n}}_{₁}_{^{⊥}}(π)e^{-iHt/2} (6)

to the target ions, where the axis of singe-qubit rotation \vec{n}ᵢ^{⊥} is perpendicular to the axis of the entangling gate \vec{n}ᵢ. As the operator σ_{\vec{n}}_{₁}_{^{⊥}}(π) σ_{\vec{n}}_{₁}_{^{⊥}}(π) anti-commutes with H_{crosstalk} while commuting with H_{ideal}, the local rotations cancel out rotations generated by the H_{crosstalk}, to obtain U=e^{-iH}^{_{ideal}}^{t}.

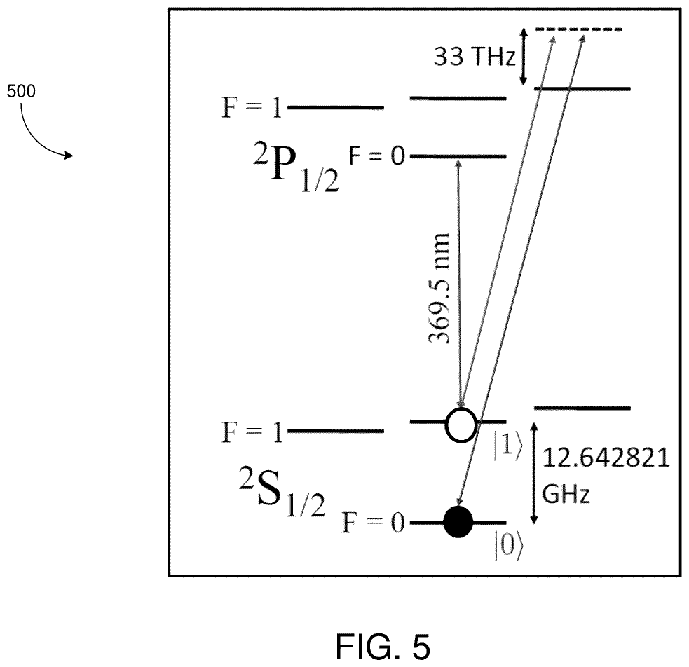

Referring now to FIG. 5, a conceptual diagram 500 representing an encoding for a ¹⁷¹Yb⁺ ion qubit is shown. As stated, the techniques described herein may be implemented within an ion trap quantum computing system, such as the system 100. In such a system, Raman beams from the laser 108 may drive entangling gates and single qubit gates. For this example, assume that the system 100 corresponds to a ¹⁷¹Yb⁺ system.

As illustrated in FIG. 5, a qubit in such a system can be encoded in hyperfine levels of ²S_{1/2} manifold. The coherence stimulated Raman transitions couple the two qubit states, labeled |0 [symbol] and |1 [symbol] , which is separated by frequency ω_{q}=2π×12.6 GHz and driven by laser fields at 355 nm. The individual beam delivery optical system enables individual manipulation of each ion qubit. As also previously stated, crosstalk may occur as a result of field spill out of individual addressing beams.

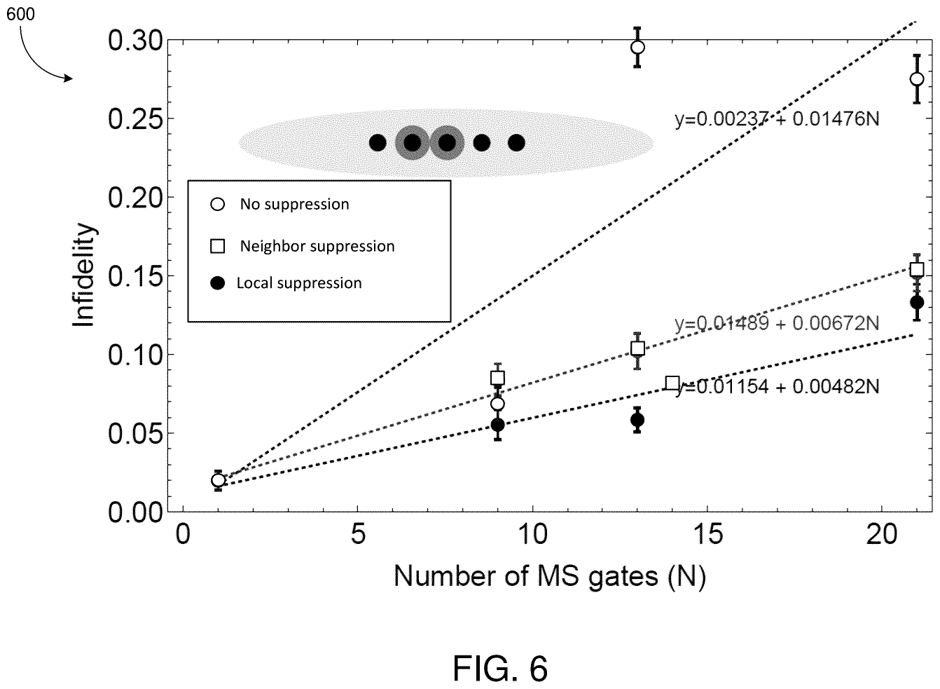

Referring now to FIG. 6, a line graph 600 presenting experimental data comparing various crosstalk suppression approaches in a five-qubit quantum circuit, including the present approach, is shown. Particularly, the graph 600 depicts gate infidelity resulting from crosstalk across N MS gates. The graph 600 provides data for an approach with no crosstalk suppression (labeled “No suppression” and indicated with white circle points), an approach using controls on neighboring qubits (labeled “Neighbor suppression” and indicated with white square points), and an approach using the techniques described herein (labeled “Local suppression” and indicated with black circle points).

Illustratively, the approach with no crosstalk suppression provides a baseline establishing that as the amount of gates increases, the gate infidelity also increases. As also shown, the approach using controls on neighboring qubits shows an increase in gate infidelity at a more gradual incline than without any crosstalk suppression applied. However, the approach using the techniques described herein has an even further gradual incline as the amount of gates increases (with a slope of 0.00482).

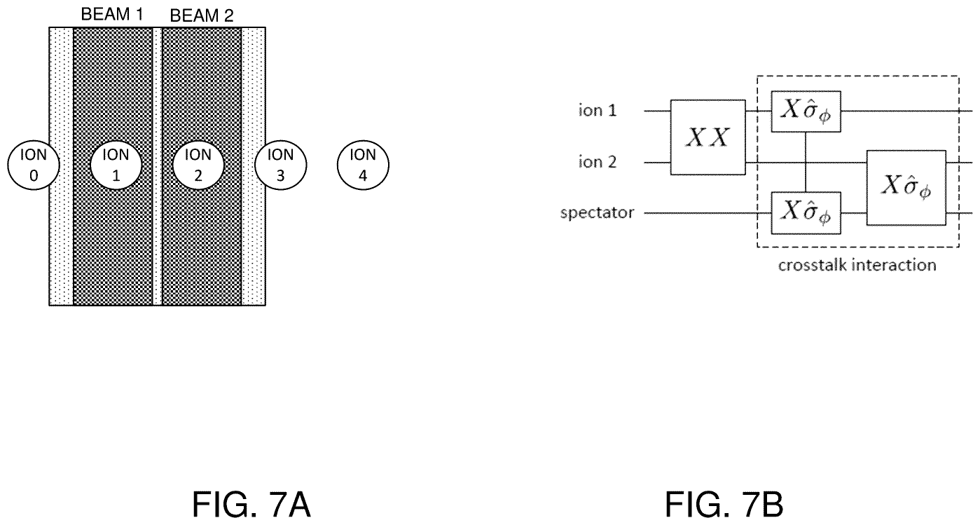

Referring now to FIGS. 7A and 7B, a simulated example of a crosstalk scenario in the system 100 is shown. More particularly, FIG. 7A depicts a conceptual schematic diagram of the chain 102 (as a 5-ion chain) in which two tightly focused beams are addressing ions 1 and 2 in the chain, and in which ions 0, 3, and 4 are neighboring spectator ions that can be impacted by intensity crosstalk. For the purpose of this example, consider a MS gate in the XX-basis, which the system 100 may express as the unitary XX(θ)=exp(−iθXX), where θ is the geometric phase of the MS gate. Imperfect optical addressing results in gate crosstalk between target ion i and a spectator ion j, which the system 100 can define as a ratio of Rabi frequencies

$$\\ {ϵ}_{ij} = \frac{{Ω}_{j}}{{Ω}_{i}} ; ( i = 1 , 2 ) ,$$

when resonantly riving single-qubit gates on ion i. ϵᵢⱼ may be in the range of 1-3% for nearest neighbors and can be below 1% using high-performance optical addressing technologies.

FIG. 7B illustrates a conceptual circuit diagram demonstrating the effect of crosstalk with one spectator qubit. The residual entanglement between each target qubit and the spectator qubit is expressed as the MS interaction X⁽ⁱ⁾\hat{σ}_{ϕ}^{(j)} where \hat{σ}_{ϕ}^{(j)}=cos(ϕ)X^{(j)}+sin(ϕ)Y^{(j)}. The ideal MS gate unitary operator is then replaced with

U_{crosstalk}(θ)=exp(−iθX⁽¹⁾X⁽²⁾)exp[−iΣ_{j≠1,2}(θ_{1,j}X⁽¹⁾\hat{σ}_{ϕ}_{ⱼ}^{(j)}+θ_{2,j}X⁽²⁾σ_{ϕ}_{ⱼ}^{(j)})], (7)

where j is the index of all affected spectator ions, and θ_{1,j} and θ_{2,j} are the respective geometric phases of the MS interactions between each target ion and ion j. For arbitrary spectator qubit states, this can generate unwanted entanglement between spectator qubits and data qubits. As known, entanglement monogamy dictates that two maximally entangled parties cannot share entanglement with a third party. Therefore, the unwanted residual entanglement with spectator qubits reduces the fidelity of entangling gates on the target qubits. For instance, consider spectator ion 3 and assume that the system initiates the qubit states of the two target and spectator ions to |0 [symbol] . After the system 100 applies the maximally entangling gate

$$\\ XX ( \frac{π}{4} )$$

to the target ions, the system 100 may calculate the fidelity of the target ion Bell state as well as the unwanted excitation of the population of the spectator ion using (7) and express each as

[symbol]

_{crosstalk}=¼(1+cos(θ_{1,3}))(1+cos(θ_{2,3})), (8)

P_{ion 3}=½(1−cos(θ_{1,3})cos(θ_{2,3})), (9)

where P_{ion 3} is equal to the |01 [symbol] and |10 [symbol] population of the target ions.

The error parameters θ_{1,j} and θ_{2,j} as well as angle ϕⱼ depend on the effective Hamiltonian of ion j, which is a product of the two individual addressing beams interfering at the location of ion j. This Hamiltonian is a function of not only the gate crosstalk ϵ₁ⱼ and ϵ₂ⱼ but also the optical phase difference ϕ_{beam} between the two addressing beams. In an embodiment, the two addressing beams are delivered via beam paths that are spatially separated, as depicted in FIG. 7A. As a result, the phase difference ϕ_{beam} drifts slowly over a timescale characterized by the stability of the Raman beam paths (˜100s of ms), which can lead to uncertainty in effective crosstalk errors.

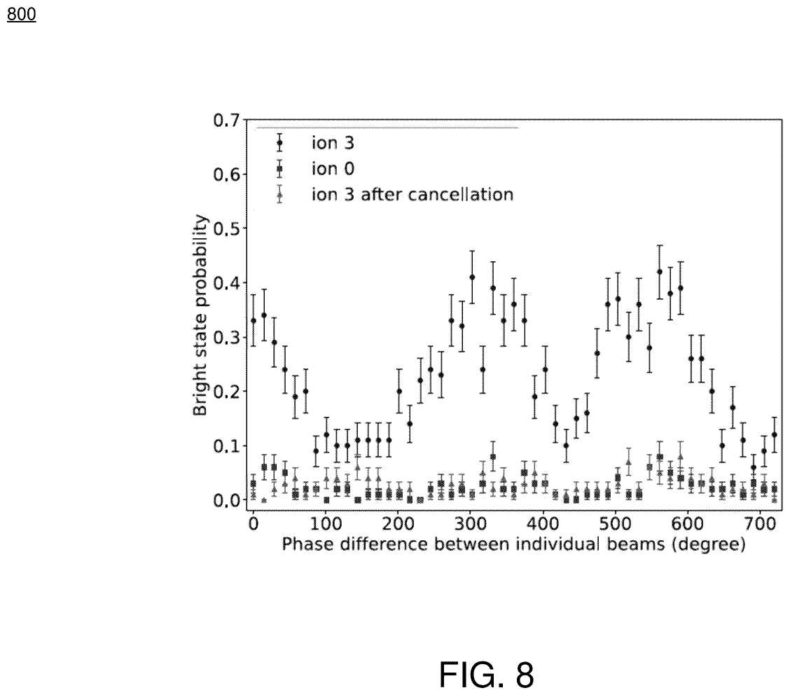

Referring now to FIG. 8, a graph 800 depicting populations of ion 0 and 3 of the continuing simulated example is shown. More particularly, the graph 800 shows measured populations of ion 0 and ion 3 after applying 21 consecutive

$$\\ XX ( \frac{π}{4} )$$

gates to ion 1 and ion 2. The optical phase of one addressing beam is scanned from 0 through 4π while the phase of the other beam is set to 0. In this example, assume that the gates are implemented by driving stimulated Raman transitions using a picosecond pulsed laser and minimizing error from coupling to all collective motional modules during the MS gate operation using discrete frequency modulation (FM). Illustratively, the population of ion 3 (indicated by the circle-shaped points) varies within a large range as the effective crosstalk depends on the phase difference ϕ_{beam}. The population of ion 0 (indicated by the square-shaped points) has a relatively smaller excitation due to ion 0 coupling to the motional modes mostly involved in the MS gate being weaker. The population of ion 3 after crosstalk suppression using the embodiments described herein are also shown (as indicated by the triangle-shaped points).

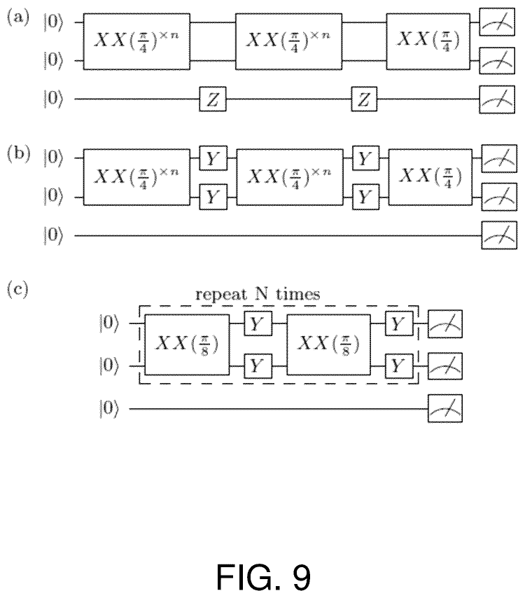

Continuing the example, various crosstalk suppression methods may be applied. FIG. 9 illustrates conceptual circuit diagrams for three different crosstalk suppression approaches: (a) a prior approach pertaining to neighbor suppression; (b) a local suppression approach in which the system 100 performs Y(π) pulses to target ions; and (c) a local suppression approach in which the system 100 splits

$$\\ XX ( \frac{π}{4} )$$

into two halt MS evolution and applies echoing Y(π) pulses after each

$$\\ XX ( \frac{π}{8} ) .$$

The neighbor suppression approach (a) follows a proof (based on (7) above):

$$\\ {[ {\prod }_{j \neq 1 , 2} {Z}^{( j )} {U}_{crosstalk} ( \frac{θ}{2} ) ]}^{2} = exp ( - i θ {X}^{( 1 )} {X}^{( 2 )} ) .$$

A single

$$\\ XX ( \frac{π}{4} )$$

is added after the second Z(π) pulse to generate the Bell state, the fidelity of which can be characterized by quantum state tomography. Note, because ϕⱼ is not well-defined due to drifting ϕ_{beam}, the prior approach requires the use of a Z gate to reverse the X\hat{σ}_{ϕj} interaction (as opposed to a Y gate). The approach may involve steering one of the addressing beams to the spectator ion to drive Z(π) rotations using MEMS mirrors. The approach applies echoing pulses only to ion 3 since the crosstalk error is dominated by θ_{1,3} and θ_{2,3}, as previously shown in graph 800 (which show, via the triangle-shaped points, the population of ion 3 after applying 21

$$\\ XX ( \frac{π}{4} )$$

gates, averaging 0.03 in contrast to 0.25 without crosstalk suppression). As previously noted, the neighbor suppression approach requires applying single-qubit gates to all affected spectator qubits, which can be up to 8 ions including the nearest and next-nearest neighbors in a long-chain system (and more if farther spectator ions have non-negligible crosstalk).

Under the local suppression techniques described herein, the system 100 achieves cancelation of all first-order crosstalk by rotating only the two target qubits, which bypasses the aforementioned MEMS beamsteering and significantly reduces resource overhead of the system 100. Illustratively, approach (b) of FIG. 9 shows an example circuit diagram for implementing a local suppression scheme in which the system 100 uses either Y(π) or Z(π) as echoing pulses on the target qubits. Because Y⁽¹⁾⊗I^{(j)} anti-commutes with X⁽¹⁾\hat{σ}_{ϕ}_{ⱼ}^{(j)}, Y⁽²⁾⊗I^{(j)} anti-commutes with X⁽²⁾\hat{σ}_{ϕ}_{ⱼ}^{(j)}, and Y⁽¹⁾⊗Y⁽²⁾ commutes with X⁽¹⁾X⁽²⁾, it follows (e.g., based on (7)) that

$$\\ {[ {Y}^{( 1 )} ⊗ {Y}^{( 2 )} {U}_{crosstalk} ( \frac{θ}{2} ) ]}^{2} = exp ( - i θ {X}^{( 1 )} {X}^{( 2 )} ) .$$

The efficacy of both neighbor and local suppression approaches is not affected by the slow drift of ϕ_{beam}, as the drift is negligible on the timescale required to complete crosstalk cancelation.

As stated, approach (c) of FIG. 9 pertains to an example of an individual-gate level approach. Particularly, although the collective-gate echo approaches described relative to approaches (a) and (b) can be useful for characterizing two-qubit gate fidelity with suppressed crosstalk errors, it may be desirable for the system 100 to apply the maximally entangling gate as a single

$$\\ XX ( \frac{π}{4} ) .$$

### Here

$$\\ XX ( \frac{π}{4} )$$

is split into two half MS evaluation and the echoing Y(π) pulses are applied after each

$$\\ XX ( \frac{π}{8} ) .$$

Continuing the previous example (beginning from FIG. 7A), the system 100 may apply a sequence of 1, 9, 13, 17, and 21 gates to ion 1 and ion 3 using local suppression. For the native gates, the population of only ion 2 (the center ion) is affected by crosstalk with negligible excitation of ion 0 and ion 4 populations due to their low motional mode participation.

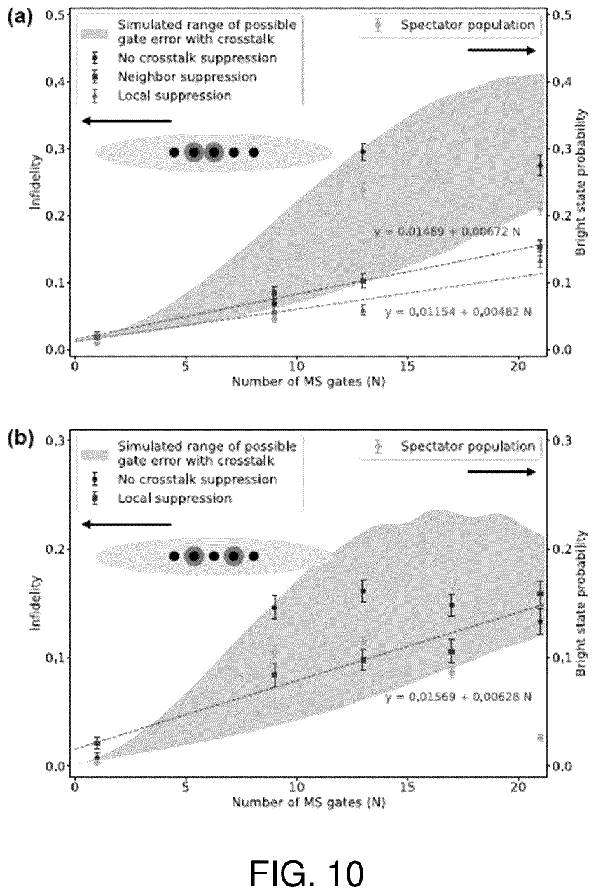

FIG. 10 illustrates the results with and without crosstalk suppression for the simulated example. A linear fit for the data using local suppression produces a two-qubit state fidelity of 99.37(5)%. The fidelity is lower than that using collective-gate local suppression as four single-qubit gates are added to each

$$\\ XX ( \frac{π}{4} ) .$$

As shown, the upper bound of an error range plateaus and starts to taper as the number of gates increases because the effect of crosstalk tends to partially cancel out for long gate sequences.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

### Examples

Illustrative examples of the technologies disclosed herein are provided below. An embodiment of the technologies may include any one or more, and any combination of, the examples described below.

Example 1 includes a method for suppressing crosstalk in a quantum circuit of a quantum computing system using local controls, comprising selecting, from a plurality of qubits in the quantum circuit, a pair of target qubits on which to perform a quantum gate operation; performing the quantum gate operation on the pair of target qubits; and inducing a rotation on at least one of the target qubits such that crosstalk between any of the target qubits and any other of the plurality of qubits in the quantum circuit resulting from the performance of the quantum gate operation is canceled out.

Example 2 includes the subject matter of Example 1, and wherein the quantum gate operation is a quantum entanglement gate operation.

Example 3 includes the subject matter of any of Examples 1 and 2, and wherein inducing the rotation on each of the target qubits comprises inducing a π-rotation on each of the target qubits.

Example 4 includes the subject matter of any of Examples 1-3, and wherein inducing the π-rotation on each of the target qubits comprises inserting the π-rotation along a Y-axis of an entangling gate associated with the quantum gate operation.

Example 5 includes the subject matter of any of Examples 1-4, and further including, receiving quantum state information of the quantum circuit.

Example 6 includes the subject matter of any of Examples 1-5, and wherein inducing the rotation on at least one of the target qubits comprises inducing the rotation on each of the target qubits.

Example 7 includes the subject matter of any of Examples 1-6, and wherein the quantum computing system is an ion trap quantum computing system.

Example 8 includes the subject matter of any of Examples 1-7, and wherein selecting the pair of target qubits comprises selecting target ions on which to perform the quantum gate operation.

Example 9 includes the subject matter of any of Examples 1-8, and wherein inducing the rotation on the target qubits comprises configuring one or more tuning parameters to generate echoing pulses sufficient to drive one or more rotations on the target ions; and applying the echoing pulses to the target ions.

Example 10 includes a quantum computing system, comprising a quantum circuit; one or more processors; and a memory storing program code having a plurality of instructions, which, when executed by the one or more processors, causes the quantum computing system to select, from a plurality of qubits in the quantum circuit, a pair of target qubits on which to perform a quantum gate operation, perform the quantum gate operation on the pair of target qubits, and induce a rotation on at least one of the target qubits such that crosstalk between any of the target qubits and any other of the plurality of qubits in the quantum circuit resulting for the performance of the quantum gate operation is canceled out.

Example 11 includes the subject matter of Example 10, and wherein the quantum gate operation is a quantum entanglement gate operation.

Example 12 includes the subject matter of any of Examples 10 and 11, and wherein to induce the rotation on each of the target qubits comprises to induce a π-rotation on each of the target qubits.

Example 13 includes the subject matter of any of Examples 10-12, and wherein to induce the π-rotation on each of the target qubits comprises to insert the π-rotation along a Y-axis of an entangling gate associated with the quantum gate operation.

Example 14 includes the subject matter of any of Examples 10-13, and wherein the plurality of instructions, when executed, further causes the quantum computing system to receive quantum state information of the quantum circuit.

Example 15 includes the subject matter of any of Examples 10-14, and wherein to induce the rotation on at least one of the target qubits comprises to induce the rotation on each of the target qubits.

Example 16 includes the subject matter of any of Examples 10-15, and wherein the quantum computing system is an ion trap quantum computing system.

Example 17 includes the subject matter of any of Examples 10-16, and wherein selecting the pair of target qubits comprises selecting target ions on which to perform the quantum gate operation.

Example 18 includes the subject matter of any of Examples 10-17, and wherein inducing the rotation on the target qubits comprises configuring one or more tuning parameters to generate echoing pulses sufficient to drive one or more rotations on the target ions; and applying the echoing pulses to the target ions.

Example 19 includes a computer-readable storage medium storing a plurality of instructions, which, when executed by one or more processors, causes a quantum computing system to select, from a plurality of qubits in a quantum circuit of the quantum computing system, a pair of target qubits on which to perform a quantum gate operation; perform the quantum gate operation on the pair of target qubits; and induce a rotation on at least one of the target qubits such that crosstalk between any of the target qubits and any other of the plurality of qubits in the quantum circuit resulting from the performance of the quantum gate operation is canceled out.

Example 20 includes the subject matter of Example 19, and wherein to induce the rotation on each of the target qubits comprises to induce a π-rotation on each of the target qubits and wherein to induce the π-rotation on each of the target qubits comprises to insert the π-rotation along a Y-axis of an entangling gate associated with the quantum gate operation.

Example 16 includes the subject matter of any of Examples 10-15, and wherein the quantum computing system is an ion trap quantum computing system.

Example 17 includes the subject matter of any of Examples 10-16, and wherein selecting the pair of target qubits comprises selecting target ions on which to perform the quantum gate operation.

Example 18 includes the subject matter of any of Examples 10-17, and wherein inducing the rotation on the target qubits comprises configuring one or more tuning parameters to generate echoing pulses sufficient to drive one or more rotations on the target ions; and applying the echoing pulses to the target ions.

Example 19 includes a computer-readable storage medium storing a plurality of instructions, which, when executed by one or more processors, causes a quantum computing system to select, from a plurality of qubits in a quantum circuit of the quantum computing system, a pair of target qubits on which to perform a quantum gate operation; perform the quantum gate operation on the pair of target qubits; and induce a rotation on at least one of the target qubits such that crosstalk between any of the target qubits and any other of the plurality of qubits in the quantum circuit resulting from the performance of the quantum gate operation is canceled out.

Example 20 includes the subject matter of Example 19, and wherein to induce the rotation on each of the target qubits comprises to induce a π-rotation on each of the target qubits and wherein to induce the π-rotation on each of the target qubits comprises to insert the π-rotation along a Y-axis of an entangling gate associated with the quantum gate operation.

1. A method for suppressing crosstalk in a quantum circuit of a quantum computing system using local controls, comprising:
selecting, from a plurality of qubits in the quantum circuit, a pair of target qubits on which to perform a quantum gate operation;
performing the quantum gate operation on the pair of target qubits; and
inducing a rotation on at least one of the target qubits such that crosstalk between any of the target qubits and any other of the plurality of qubits in the quantum circuit resulting from the performance of the quantum gate operation is canceled out.

2. The method of claim 1, wherein the quantum gate operation is a quantum entanglement gate operation.

3. The method of claim 1, wherein inducing the rotation on each of the target qubits comprises inducing a π-rotation on each of the target qubits.

4. The method of claim 3, wherein inducing the π-rotation on each of the target qubits comprises inserting the π-rotation along a Y-axis of an entangling gate associated with the quantum gate operation.

5. The method of claim 1, further comprising, receiving quantum state information of the quantum circuit.

6. The method of claim 1, wherein inducing the rotation on at least one of the target qubits comprises inducing the rotation on each of the target qubits.

7. The method of claim 1, wherein the quantum computing system is an ion trap quantum computing system.

8. The method of claim 7, wherein selecting the pair of target qubits comprises selecting target ions on which to perform the quantum gate operation.

9. The method of claim 8, wherein inducing the rotation on the target qubits comprises:
configuring one or more tuning parameters to generate echoing pulses sufficient to drive one or more rotations on the target ions; and
applying the echoing pulses to the target ions.

10. A quantum computing system, comprising:
a quantum circuit;
one or more processors; and
a memory storing program code having a plurality of instructions, which, when executed by the one or more processors, causes the quantum computing system to:
select, from a plurality of qubits in the quantum circuit, a pair of target qubits on which to perform a quantum gate operation,
perform the quantum gate operation on the pair of target qubits, and
induce a rotation on at least one of the target qubits such that crosstalk between any of the target qubits and any other of the plurality of qubits in the quantum circuit resulting for the performance of the quantum gate operation is canceled out.

11. The quantum computing system of claim 10, wherein the quantum gate operation is a quantum entanglement gate operation.

12. The quantum computing system of claim 10, wherein to induce the rotation on each of the target qubits comprises to induce a π-rotation on each of the target qubits.

13. The quantum computing system of claim 12, wherein to induce the π-rotation on each of the target qubits comprises to insert the π-rotation along a Y-axis of an entangling gate associated with the quantum gate operation.

14. The quantum computing system of claim 10, wherein the plurality of instructions, when executed, further causes the quantum computing system to receive quantum state information of the quantum circuit.

15. The quantum computing system of claim 10, wherein to induce the rotation on at least one of the target qubits comprises to induce the rotation on each of the target qubits.

16. The quantum computing system of claim 10, wherein the quantum computing system is an ion trap quantum computing system.

17. The quantum computing system of claim 16, wherein selecting the pair of target qubits comprises selecting target ions on which to perform the quantum gate operation.

18. The quantum computing system of claim 17, wherein inducing the rotation on the target qubits comprises:
configuring one or more tuning parameters to generate echoing pulses sufficient to drive one or more rotations on the target ions; and
applying the echoing pulses to the target ions.

19. A computer-readable storage medium storing a plurality of instructions, which, when executed by one or more processors, causes a quantum computing system to:
select, from a plurality of qubits in a quantum circuit of the quantum computing system, a pair of target qubits on which to perform a quantum gate operation;
perform the quantum gate operation on the pair of target qubits; and
induce a rotation on at least one of the target qubits such that crosstalk between any of the target qubits and any other of the plurality of qubits in the quantum circuit resulting from the performance of the quantum gate operation is canceled out.

20. The computer-readable storage medium of claim 19, wherein to induce the rotation on each of the target qubits comprises to induce a π-rotation on each of the target qubits and wherein to induce the π-rotation on each of the target qubits comprises to insert the π-rotation along a Y-axis of an entangling gate associated with the quantum gate operation.
